(19) United States
(12) Patent Application Publication
(10) Pub. No.: US 2019/0326735 A1
(43) Pub. Date: Oct. 24, 2019

(54) INSTALLATION OF SIGNAL CABLES THROUGH COILED TUBING USING DISSOLVABLE BULLETS

(71) Applicant: Halliburton Energy Services, Inc., Houston, TX (US)

(72) Inventors: Bharat B. Pawar, Duncan, OK (US); Bryan John Lewis, Duncan, OK (US); Dustin Myron Dell, Duncan, OK (US)

(21) Appl. No.: 16/311,646

(22) PCT Filed: Jul. 1, 2016
(86) PCT No.: PCT/US2016/040848

§ 371 Date: Dec. 19, 2018

(51) Int. Cl. H02G 1/08; E21B 17/20

(52) U.S. Cl. CPC H02G 1/086; H02G 1/088; E21B 17/206

(57) ABSTRACT

Methods for installing a signal cable through a coiled tubing strand include installing a front end bullet at a leading end of the signal cable and dissolvable bullets at intermediate locations along the signal cable. A pushing fluid is injected into the coiled tubing strand to apply a drive force to both the front end bullet and the dissolvable bullets to thereby advance the signal cable through the coiled tubing strand. Once the front end bullet passes through the coiled tubing strand, the front end bullet may be removed, and a solvent fluid is injected to remove the dissolvable bullets inside coiled tubing strand. The dissolvable bullets permit the pushing fluid to greater drag forces to advance the signal cable, while reducing the friction generated between the signal cable and an inner wall of the coiled tubing strand that usually act in a direction opposite the drag forces.

### BACKGROUND

The present disclosure relates generally to equipment useful in operations related to subterranean wellbores, e.g., wellbores employed for oil and gas exploration, drilling and production. More particularly, embodiments of the disclosure relate to systems and methods for installing a signal cable through a coiled tubing strand prior to deployment of the coiled tubing strand into the wellbore.

In operations related to the production of hydrocarbons from subterranean geologic formations, coiled tubing is often employed to facilitate wellbore drilling, maintenance, treatment, stimulation and other wellbore processes. Coiled tubing generally includes a continuous strand of a flexible tube that may be wound and unwound from a spool. The length of a coiled tubing strand may be in the range of about 10,000 feet to about 30,000 feet in some instances, and thus, the coiled tubing strand may be unwound from a spool to readily lower a downhole tool to a subterranean location at a significant depth in a wellbore. Often, a signal cable may be provided through the coiled tubing strand to enable communication with the downhole tool. Downhole tools, e.g., well logging tools, may use the signal cable to transmit data to the surface location, and/or the signal cable may be used to transmit instructions and electrical power to the downhole tool.

Various techniques have been employed to insert the signal cable into the coiled tubing strand. For example, the coiled tubing strand may first be uncoiled into a wellbore, and the signal cable may then be fed through the coiled tubing strand by gravity, or carried by a fluid pumped downhole through the coiled tubing strand.

### BRIEF DESCRIPTION OF THE DRAWINGS

The disclosure is described in detail hereinafter, by way of example only, on the basis of examples represented in the accompanying figures, in which:

FIG. 1 is a partially cross-sectional side view of a cable installation system employing a plurality of dissolvable bullet assemblies interspaced longitudinally along the length of a signal cable for injecting the signal cable through a coiled tubing strand;

FIG. 2 is a perspective view of the signal cable of FIG. 1 illustrating an example arrangement of the bullet assemblies along the signal cable;

FIG. 3 is a perspective view with parts separated of a dissolvable bullet assembly illustrating split body portions and fasteners for coupling the split body portions around the signal cable;

FIGS. 4 through 6 are perspective views of dissolvable bullet assemblies illustrating alternate split body portion geometries; and

FIGS. 7A and 7B are a flowchart illustrating an operational procedure for installing the signal cable through the coiled tubing strand.

### DETAILED DESCRIPTION

The present disclosure includes methods and devices for installing a signal cable through a coiled tubing strand while the coiled tubing strand is wound on a reel at a surface location. A front end bullet is installed at a leading end of the signal cable, and inserted into a first end of the coiled tubing strand. As used herein, the term “bullet” includes any protuberance that protrudes radially from the signal cable and applies a force on the signal cable in a direction of fluid flow through the coiled tubing strand. A pushing fluid injected to apply a drive force to both the front end bullet and the signal cable to advance the signal cable partially through the coiled tubing strand. At least one dissolvable bullet is then installed on the signal cable at an intermediate location along the signal cable that is spaced from the front end bullet. The pushing fluid is again injected to apply a drive force to the front end bullet, the signal cable and the dissolvable bullet to further advance the signal cable. Once the front end bullet passes completely through the coiled tubing strand, the front end bullet may be retrieved through a second end of the coiled tubing strand and removed from the signal cable. The at least one dissolvable bullet may remain in the coiled tubing strand, and may be removed by injecting a solvent fluid to thereby dissolve at least a portion of the at least one dissolvable bullet. The leading end of the signal cable may then be coupled to surface equipment, and a trailing end of the signal cable may be coupled to a downhole tool or instrument. The downhole tool or instrument may then be deployed into the wellbore on the coiled tubing strand as the coiled tubing is unwound from the reel.

In some instances, the downhole tool or instrument may be coupled to the leading end of the signal cable while the surface equipment may be coupled to the trailing end of the signal cable. In these instances, the coiled tubing strand may be unwound from the reel at the surface to facilitate coupling the downhole tool or instrument to the second end of the coiled tubing strand, which is generally at the center of the reel. In either case, the downhole tool or instrument may maintain communication with the surface equipment through the signal cable extending through the coiled tubing strand.

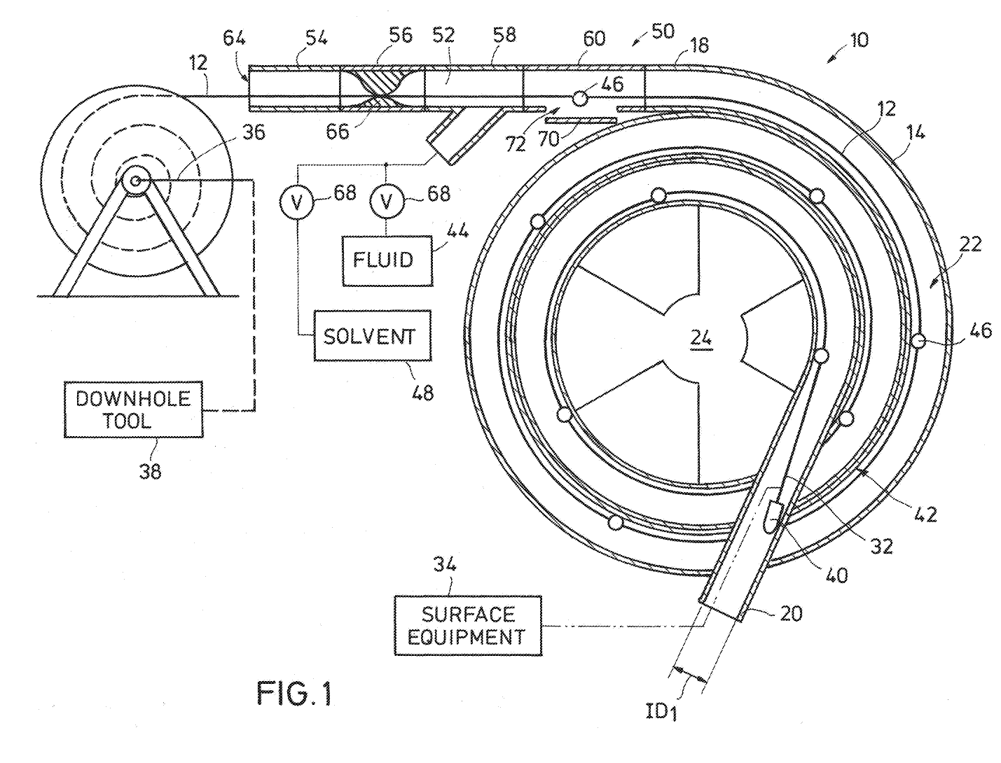

FIG. 1 is a partially cross-sectional side view of a system 10 for deploying a signal cable 12 through a coiled-tubing strand 14. In some example embodiments, the signal cable 12 comprises an armored optical cable operable to transmit photo-optic signals therethrough. In other embodiments, it should be appreciated that the signal cable 12 may additionally or alternatively operate to transmit electrical power and or data. Coiled tubing strand 14 is generally used to conduct various drilling and production operations, and is characterized by a distal or first end 18, a proximal or second end 20 and inner flow path 22 extending therebetween. The coiled tubing strand 14 is stored on a reel assembly or spool 24 (e.g., by being wrapped about the spool). As used herein the term “coiled tubing” will include any continuous or joined pipe string that may be wound on a spool or otherwise deployed rapidly including continuous metal tubulars such as low-alloy carbon-steel tubulars, composite coiled tubulars, capillary tubulars and the like.

With the signal cable 12 extending entirely through the flow path 22, a leading end 32 of the signal cable 12 may be communicatively coupled to surface equipment 34, and a trailing end 36 of the signal cable 12 may be communicatively coupled to a downhole tool or instrument 38. The downhole tool or instrument 38 may then be supported on the first end 18 of the coiled tubing strand 14 and deployed into a wellbore (not shown) as the coiled tubing strand 14 is un-wound from the spool 24. The surface equipment 34 may transmit instructions and/or receive data through the signal cable 12.

A front end bullet 40 is installed on the signal cable 12 and circumscribes the leading end 32 thereof. The front end bullet 40 is substantially smaller than an inner diameter ID₁ of the coiled tubing strand 14 such that the front end bullet 40 maintains a substantially unsealed relation with an inner wall 42 of the coiled tubing strand 14 when passing therethrough. Drag forces are generated on the front end bullet 40 as a pushing fluid 44 is injected through the flow path 22 and around the front end bullet 40. The pushing fluid 44 may be a pumped or pressurized fluid, e.g., air, water, gel, oil, gas, etc., and drag forces generated on the front end bullet 40 and on the signal cable 12 drag forces draw the signal cable 12 through the coiled tubing strand 14 in the direction of the fluid flow. In some embodiments, the front end bullet 40 may be constructed of a substantially non-dissolvable material such as steel, and in other embodiments, the front end bullet 40 (or portions thereof) may be constructed of a dissolvable material as described below.

At least one dissolvable bullet 46 is installed on the signal cable 12 at an intermediate location spaced from the front end bullet 40. The dissolvable bullet or bullets 46 circumscribe the signal cable 12, and support the signal cable 12 by a height “h” above the inner wall 42 of the coiled tubing strand 14. The friction generated between the dissolvable bullets 46 and the inner wall 42 may be substantially lower than the friction that would otherwise be generated if the signal cable 12 were in contact the inner wall 42. As illustrated in FIG. 1, a sufficient number of dissolvable bullets 46 of a predetermined size are provided at appropriate intermediate locations along the signal cable 12 such that the signal cable 12 does not contact the inner wall 42. However, it should be appreciated that in some embodiments, the spacing and/or sizing of the dissolvable bullets 46 may permit portions of the signal cable to contact the inner wall 42.

The dissolvable bullets 46 are constructed, at least in part, of a “dissolvable material” that degrades in the presence of a solvent fluid 48. As used herein, a “dissolvable material” includes at least hydrolytically degradable materials such as elastomeric compounds that contain polyurethane, aliphatic polyesters, thiol, cellulose, acetate, polyvinyl acetate, polyethylene, polypropylene, polystyrene, natural rubber, polyvinyl alcohol, or combinations thereof. Aliphatic polyester has a hydrolysable ester bond and will degrade in water. Examples include polylactic acid, polyglycolic acid, polyhydroxyalkonate, and polycaprolactone. A “dissolvable material” may also include metals that have an average dissolution rate in excess of 0.01 mg/cm²/hr. at 200° F. in a 15% KCl solution. A component constructed of a dissolvable material may lose greater than 0.1% of its total mass per day at 200° F. in a 15% KCl solution. In some embodiments, the dissolvable metal material may include an aluminum alloy and/or a magnesium alloy. Magnesium alloys include those defined in ASTM standards AZ31 to ZK60. In some embodiments, the magnesium alloy is alloyed with a dopant selected from the group consisting of iron, nickel, copper and tin. The dissolvable solvent fluid 48 may include water, a saline solution with a predetermined salinity, an HCl solution and/or other fluids depending on the selection and arrangement of the dissolvable bullets 46.

In some embodiments, the solvent fluid 48 may be the same fluid as the pushing fluid 44. For example, the pushing fluid 44 may operate to degrade the dissolvable bullets 46 as the signal cable 12 is being advanced into the coiled tubing strand 12, or in a sufficient time interval time to permit the signal cable 12 to be fully advanced before degrading the dissolvable bullets 46. In some embodiments, the solvent fluid 48 may have a temperature or salinity that is different than a temperature or salinity of the pushing fluid 44 such that exposure to the pushing fluid 44 does not induce dissolving of the at least one dissolvable bullet 46. In some embodiments, the solvent fluid 48 is entirely distinct from the pushing fluid 44.

Coupled to the first end 18 of the coiled tubing strand 14 is a conduit assembly 50. An interior passageway 52 is defined through the conduit assembly 50, and is in fluid communication with the inner flow path 22 of the coiled tubing strand 14. The conduit assembly 50 generally includes a receiving tube 54, a stripper packer 56, a fluid inlet port 58 and a hatch pipe 60.

The receiving tube 54 has a front end opening 64 through which the signal cable may be introduced into the interior passageway 52. The signal cable 12 passes through the stripper packer 56, which includes a packing element 66. The packing element 66 may include an elastomeric member that depends on a downstream fluid pressure to effect a seal in the interior passageway 52 about the signal cable 12. The fluid inlet port 58 provides fluid communication between the interior passageway 52 and the sources of the pushing fluid 44 and the solvent fluid 48. Valve assemblies 68 may be provided to selectively inject the pushing fluid 44 and solvent fluid 48 individually or in combination into the interior passageway 52. The stripper packer 56 ensures that the fluids 44, 48 do not flow back toward the receiving tube 54, but are instead directed into the inner flow path 22 of the coiled tubing strand 14.

The hatch pipe 60 includes a selectively removable hatch 70 that may be removed to create an opening 72 in the conduit assembly 50. The opening 72 is sized to permit installation of the dissolvable bullets 46 onto an intermediate location on the signal cable 12 when the leading end 32 of the signal cable 12 is disposed within the coiled tubing strand 14. The opening is disposed downstream of the fluid inlet port 58, and thus, the hatch 70 may be removed to install a dissolvable bullet 46 onto the signal cable 12 through the opening 72, and then may be replaced to seal the interior passageway 52 to thereby facilitate advancement of the dissolvable bullet 46 with the pushing fluid 44. In some embodiments (not show), an appropriate opening 72 for installing a dissolvable bullet 46 may be created in the conduit assembly 50 without a hatch pipe 60. For example, an opening 72 may be created by decoupling the fluid inlet port 58 from the component downstream of the fluid port to expose an intermediate location of the signal cable 12.

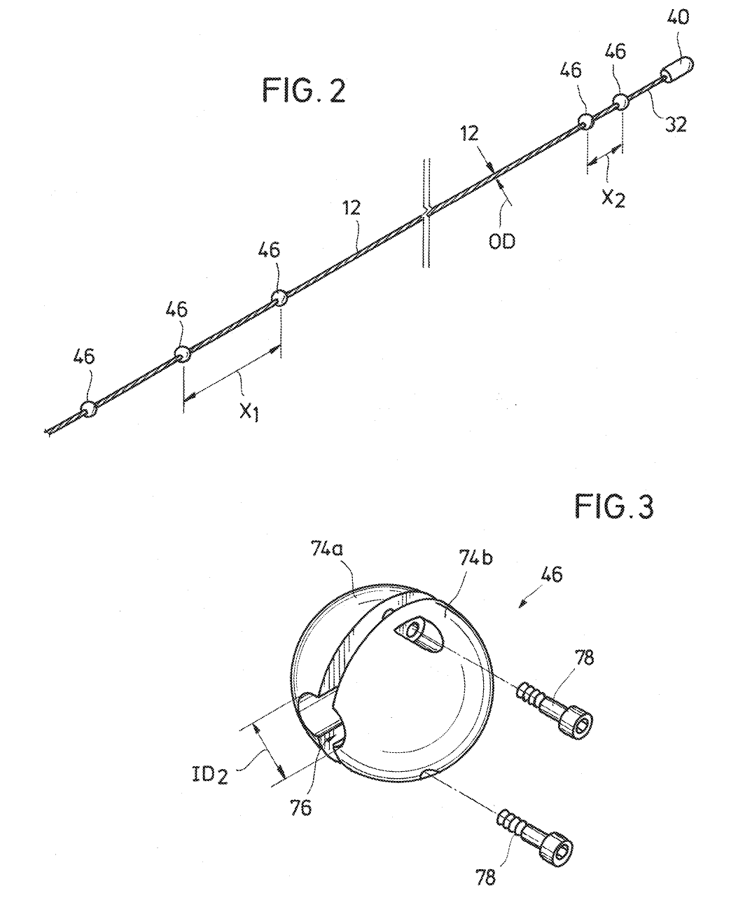

FIG. 2 is a perspective view of the signal cable 12 illustrating an example arrangement of the bullet assemblies 40, 46. The front end bullet 40 is affixed to the leading end 32 of the signal cable 12, and circumscribes an outer diameter “OD” of the signal cable 12. Dissolvable bullets 46 are coupled at intermediate locations along the signal cable 12 spaced from the front end bullet 40. The dissolvable bullets 46 may be separated from one another by an interval distance “X₁,” which may be regular or irregular. In some embodiments, the interval distance may be in the range of about 100 feet to about 1000 feet. In some embodiments, an interval distance “X₂” between dissolvable bullets 46 closer to the leading end 32 may be smaller than the interval distance “X₁” between dissolvable bullets 46 more distant from the leading end 32.

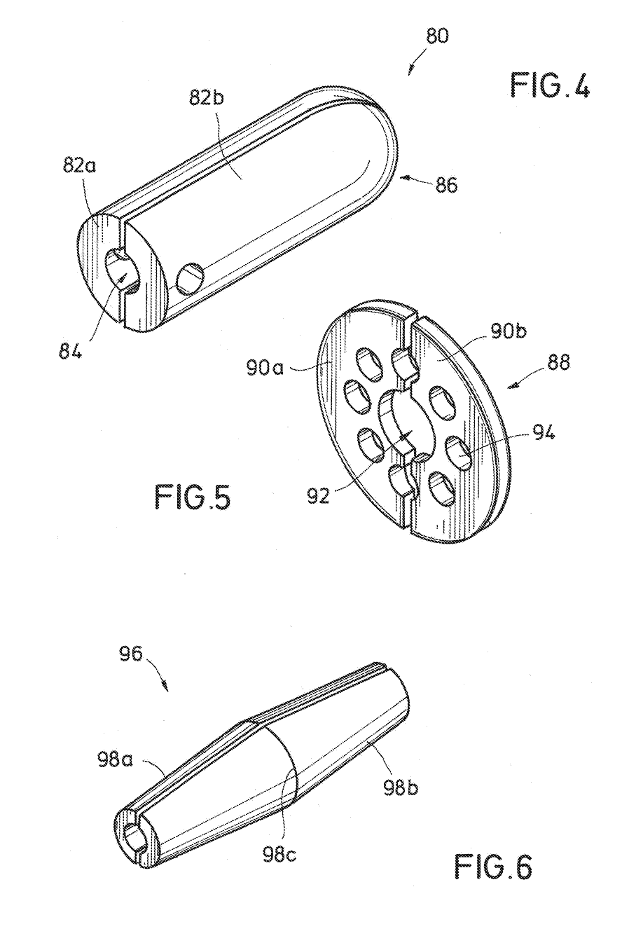

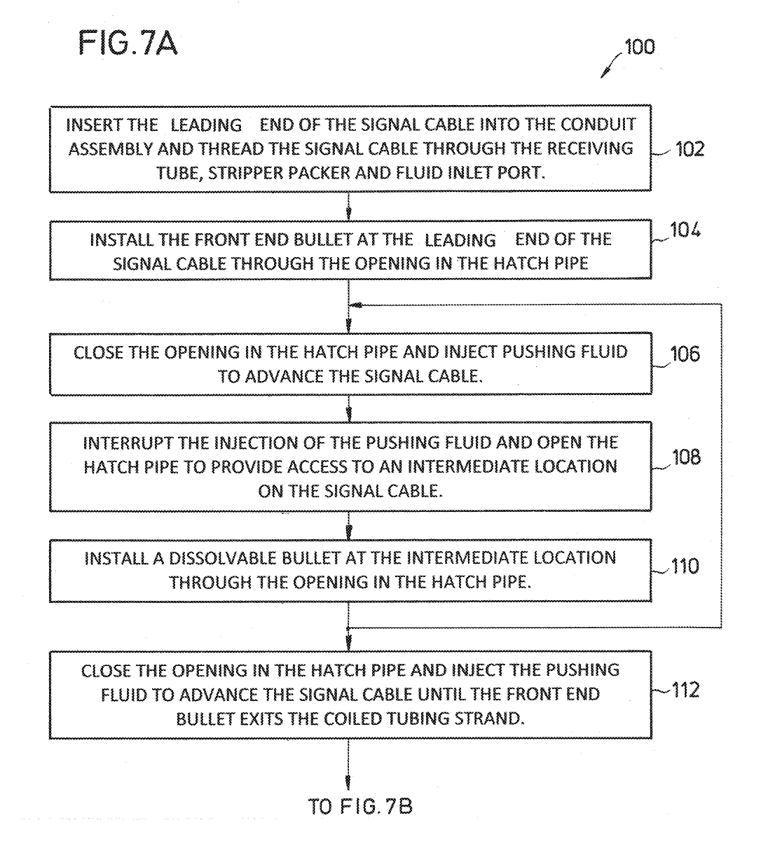

FIG. 3 is a perspective view with parts separated of a dissolvable bullet 46. The dissolvable bullet 46 incudes split body portions 74a, 74b that together define an inner passage 76 extending therethrough. The inner passage 76 may have an inner diameter ID₂ that is substantially similar to the outer diameter “OD” of the signal cable 12 (FIG. 2), and, thus, when fasteners 78 are installed to couple the split body portions 74a, 74b to one another, the dissolvable bullet 40 may be firmly secured to outer diameter OD of the signal cable 12. In some embodiments, the fasteners 78 may be sufficiently tightened to clamp the split body 30 portions 74a, 74b tightly enough around the signal cable 12 such that the dissolvable bullets 46 do not travel along the signal cable 12 as the pushing fluid 44 (FIG. 1) flows through the coiled tubing strand. In other embodiments, the dissolvable bullets 44 may travel along the signal cable 12 as long as the dissolvable bullets apply a force on the signal cable 12 in the direction of the flow of the pushing fluid 44. The split body portions 74a, 74b and/or the fasteners 78 may be constructed of a dissolvable material such that the dissolvable bullet 46 separates from the signal cable 12 in the presence of the solvent fluid 48 (FIG. 1). When coupled to one another, the split body portions 74a, 74b together define a substantially spherical geometry. In some instances, a spherical geometry may provide for sufficiently high drag forces from the pushing fluid 44 (FIG. 1) and sufficiently low frictional forces from the inner wall 42 of the coiled tubing strand 14 to draw the signal cable through the coiled tubing string. In other embodiments dissolvable bullets (see FIGS. 4-6) may have other geometries to accommodate a coiled tubing strand 14 with a longer length and smaller inner diameter ID₁ (FIG. 1).

FIG. 4 is a perspective view of a dissolvable bullet 80 including elongated split body portions 82a, 82b. An inner passage 84 extends through the elongated body portions to receive the signal cable 12 therethrough. A rounded leading end 86 may help to prevent the dissolvable bullet becoming stuck with in the coiled tubing strand 14 (FIG. 1). The elongated geometry and rounded leading end 86 of the dissolvable bullet 86 may also be employed, e.g., in the leading end bullet 40 (FIG. 1). The inner passage 84 need not extend through the rounded leading end 86 when this geometry is employed as a leading end bullet.

FIG. 5 is a perspective view of a dissolvable bullet 88 including split body portions 90a, 90b. The body portions 90a, 90b form generally flat discs with an inner passage 92 extending therethrough for receiving the signal cable 12. An array of flow openings 94 are provided around the inner passage 92 and permit flow of the pushing fluid 44 (FIG. 1) and the solvent fluid 48 (FIG. 1) therethrough. The number, size and shape of the flow openings 94 may be selected to achieve a desired drag force with the pushing fluid 44, and the may be selected to provide an appropriate surface area to achieve a desired dissolution rate with the solvent fluid 48.

FIG. 6 is a perspective view of a dissolvable bullet 96 including elongated split body portions 98a, 98b. The body portions 98a, 98b are elongated and taper generally from a longitudinal center 98c to both leading and trailing ends. The longitudinal center 98c thus defined a peak diameter of the dissolvable bullet 96, and the longitudinal center 98c may rest on the inner wall 42 (FIG. 1) of the coiled tubing strand 14 (FIG. 1). This single point of contact may allow a relatively small frictional force to be generated between the dissolvable bullet 96 and the coiled tubing strand 14.

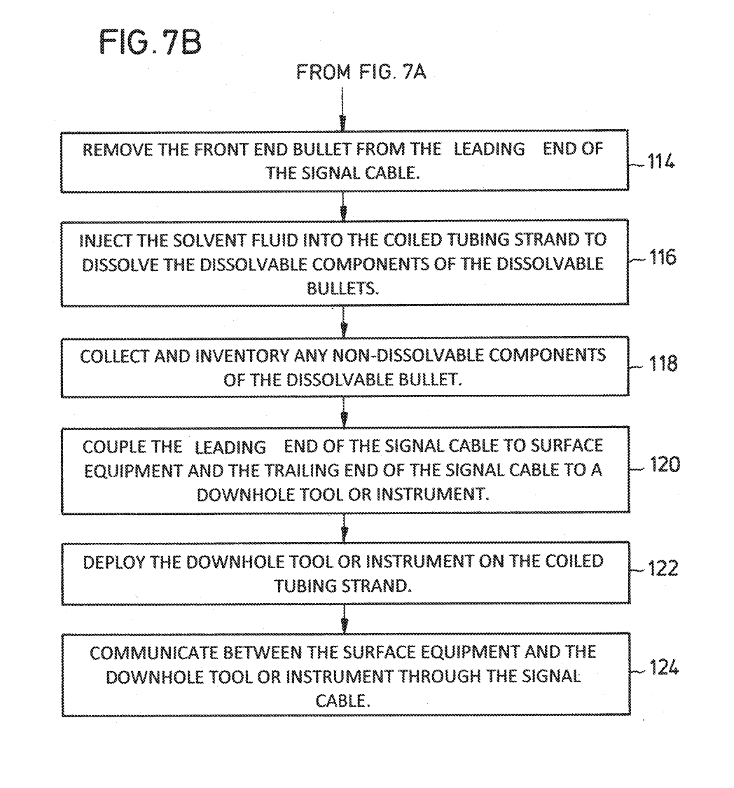

FIGS. 7A and 7B are a flow chart illustrating an operational procedure 100 for installing the signal cable 12 through the coiled tubing strand 14. With reference to FIGS. 7A and 7B and continued reference to FIGS. 1 through 3, the procedure 100 begins at step 102 where the leading end 32 of the signal cable 12 is inserted into the conduit assembly 50. The leading end 32 is inserted through the front end opening 64 of the receiving tube 54 and threaded through the stripper packer 56, and fluid inlet port 58 into the hatch pipe 60. Although in some embodiments, the bullets 40, 46 may be pre-installed on the signal cable, the operational procedure 100 begins with the signal cable 12 free of the front end bullet 40 and dissolvable bullets 46.

At step 104, the front end bullet 40 may be installed to the leading end 32 of the signal cable 12 through the opening 72 in the hatch pipe 60. For example, split body portions, e.g., split body portions 82a, 82b (FIG. 4), may be inserted into interior passageway 52 through the opening 72, and arranged to circumscribe the signal cable 12. Fasteners 78 may then be employed to secure the body portions 82a, 82b to one another and to the signal cable 12. Next, the hatch 70 may then be replaced to close the opening 72 (step 106), and the valves 68 may be manipulated to inject pushing fluid 44 into the interior passageway 52 through the fluid inlet port 58. The pressure in fluid inlet port 58 may cause the packing element 66 to seal around the signal cable 12 and direct the pushing fluid 44 through the hatch pipe 60 and into the inner flow path 22 of the coiled tubing strand 14. The drag forces generated as the pushing fluid 44 passes around the signal cable 12 and front end bullet 40 draw the signal cable into the coiled tubing strand 14.

At step 108, the injection of the pushing fluid 44 is interrupted while the front end bullet 40 is disposed within the coiled tubing strand 14 and an intermediate location on the signal cable 12 is disposed within the hatch pipe 60. The hatch 70 may be removed to provide access to the intermediate location, and a dissolvable bullet 46 may be installed on the signal cable 12 (step 110). The procedure 100 may then return to step 106 where the signal cable 12 may further advanced by an interval “X₂” and further dissolvable bullets 46 may be installed on the signal cable 12.

By iteratively repeating steps 106 through 110, all of the dissolvable bullets 46 may be installed on the signal cable 12 as the signal cable 12 is advanced into the coiled tubing strand 14. Alternatively or additionally, the front end bullet 40 and/or dissolvable bullets 46 may be preinstalled on the signal cable 12, e.g., the bullets 40, 46 may be installed prior to step 102 where the leading end 32 of the signal cable 12 is inserted into the conduit assembly 50. When all of the dissolvable bullets 46 are installed, the procedure 100 may advance to step 112 where the hatch 70 is closed and the pushing fluid 44 is again injected to advance the signal cable 12 until the front end bullet 40 exits through the second end 20 of the coiled tubing strand 14. The signal cable 12 then extends fully through the coiled tubing strand 14.

At step 114, the front end bullet 40 may be removed from the leading end 32 of the signal cable 12, and then the valves 68 may be manipulated to inject the solvent fluid 48 into the coiled tubing strand 14 (step 116). Where the fasteners 78 of the dissolvable bullets 46 are constructed of a dissolvable material and the split body portions 74a, 74b are constructed of a non-dissolvable material, the solvent fluid induces disintegration of the fasteners 78 such that the split body portions 74a, 74b separate from the signal cable 12. The solvent fluid 48 may then carry the split body portions 74a, 74b to second end 20 of the coiled tubing strand 14. The split body portions 74a, 74b and any other non-dissolvable components of the dissolvable bullets 46 may then exit the coiled tubing strand 14 where they may be collected and inventoried (step 118) to ensure that no debris from the dissolvable bullets 46 remain in the coiled tubing strand 14. Alternatively, in some embodiments, the dissolvable bullets 46 may be fully dissolved within the coiled tubing strand 14.

Once the dissolvable bullets 46 are removed from the signal cable 12, the conduit assembly 50 may be removed from the first end 18 of the coiled tubing strand 14, the leading end 32 of the signal cable 12 may be operatively coupled to the surface equipment 34 and the trailing end 36 of the signal cable 12 may be operatively coupled to a downhole tool or instrument 38 (step 120). Next, at step 122, the downhole tool or instrument 38 may be coupled to the coiled tubing strand 14 and deployed into a wellbore on the coiled tubing strand 14 by conventional methods. The surface equipment 34 and the downhole tool or instrument may then communicate with one another through the signal cable 12 (step 124). With the dissolvable bullets 46 removed from the signal cable 12, fluids may be transmitted through the coiled tubing strand 14 without the dissolvable bullets 46 becoming dislodged and 30 creating debris in the wellbore.

The aspects of the disclosure described below are provided to describe a selection of concepts in a simplified form that are described in greater detail above. This section is not intended to identify key features or essential features of the claimed subject matter, nor is it intended to be used as an aid in determining the scope of the claimed subject matter.

In one aspect, the disclosure is directed to a method of deploying at least one signal cable through a coiled-tubing strand. The method includes (1) installing a front end bullet at a leading end of the signal cable, (2) installing at least one dissolvable bullet on the signal cable at an intermediate location along the signal cable such that the at least one dissolvable bullet protrudes radially from the signal cable at the intermediate location spaced from the front end bullet, (3) positioning the leading end of the signal cable into a conduit assembly that extends to a first end of the coiled tubing strand, (4) injecting a pushing fluid into the conduit assembly to apply a drive force to both the front end bullet and the at least one dissolvable bullet to thereby drive the signal cable into the coiled tubing strand through the conduit assembly, and (5) injecting a solvent fluid into the conduit assembly to thereby dissolve the at least one dissolvable bullet.

In some embodiments, the front end bullet and/or the dissolvable bullets are preinstalled on the signal cable prior to inserting positioning the leading end of the signal cable into the conduit assembly or the coiled tubing strand. In other embodiments, the front end bullet and/or dissolvable bullets are installed on the signal cable as the signal cable is driven into the coiled tubing strand.

In some embodiments, the method further includes either retrieving the front end bullet from a second end of the coiled tubing strand at a surface location or dissolving the front end bullet within the coiled tubing strand at the surface location. The method may further comprise interrupting injection of the pushing fluid prior to retrieving or dissolving the front end bullet, installing the at least one dissolvable bullet on the signal cable while the injection of the pushing fluid is interrupted, and resuming the injection of the pushing fluid. The method may include creating an opening in the conduit assembly while the injection of the pushing fluid is interrupted, installing the at least one dissolvable bullet through the opening and subsequently closing the opening and resuming the injection of pushing fluid. The method may also include inserting the leading end of the signal cable and the front end bullet through an end of the conduit assembly disposed upstream of the opening.

In some example embodiments, installing the at least one dissolvable bullet on the signal cable includes coupling at least two split body portions to one another around the signal cable. Injecting the solvent fluid to thereby dissolve the at least one dissolvable bullet may include dissolving a fastener constructed of a dissolvable material to permit the at least two split body portions to separate from one another and separate from the signal cable within the coiled tubing strand. The method may also include discharging the at least two split body portions from the second end of the coiled tubing string. In some embodiments, injecting the solvent fluid to thereby dissolve the at least one dissolvable bullet includes dissolving the at least two split body portions with the solvent fluid within the coiled tubing strand.

In one or more example embodiments, injecting the solvent fluid to dissolve the at least one dissolvable bullet may include injecting a hydrochloric acid solution into the conduit assembly. Installing the at least one dissolvable bullet on the signal cable may include installing a plurality of dissolvable bullets at predetermined intervals along the signal cable. The predetermined interval may be selected based on an inner diameter of the coiled tubing strand. The method may further include flowing the pushing fluid through the coiled tubing strand and around the front end bullet within the coiled tubing strand.

In another aspect, the disclosure is directed to a system for deploying a signal cable through a coiled-tubing strand. The system includes a front end bullet selectively attachable to a leading end of the signal cable and at least one dissolvable bullet selectively attachable to an intermediate location of the signal cable spaced from the leading end. The system also includes a conduit assembly coupled to a first end of the coiled tubing strand and in fluid communication therewith and a source of pushing fluid fluidly coupled to the conduit assembly. The pushing fluid is selectively releasable into the conduit assembly to apply a drive force to both the front end bullet and the at least one dissolvable bullet to thereby drive the signal cable into the coiled tubing strand through the conduit assembly. The system includes a source of solvent fluid selectively injectable into the conduit assembly to thereby dissolve the at least one dissolvable bullet within the coiled tubing strand, and also includes an opening defined in the conduit assembly to provide access to an intermediate location of the signal cable when the leading end of the signal cable is disposed within the coiled tubing strand.

In one or more example embodiments, the at least one dissolvable bullet includes at least two split body portions selectively attachable to one another around the signal cable through the opening in the conduit assembly to thereby couple the at least one dissolvable bullet to the signal cable. The at least one dissolvable bullet includes a fastener constructed of a dissolvable material responsive to exposure to the solvent fluid to dissolve and thereby permit the at least two split body portions to separate from one another and separate from the signal cable. At least a portion of the at least one dissolvable bullet may be constructed of polyglycolic acid (PGA), and the solvent fluid may include a hydrochloric acid solution.

In some example embodiments, the front end bullet is substantially smaller than an inner diameter of the coiled tubing strand such that the front end bullet maintains a substantially unsealed relation with the coiled tubing strand when disposed therein. The source of solvent fluid may have a temperature or salinity that is different than a temperature or salinity of the pushing fluid such that exposure to the pushing fluid does not induce dissolving of the at least one dissolvable bullet.

The Abstract of the disclosure is solely for providing the United States Patent and Trademark Office and the public at large with a way by which to determine quickly from a cursory reading the nature and gist of technical disclosure, and it represents solely one or more examples.

While various examples have been illustrated in detail, the disclosure is not limited to the examples shown. Modifications and adaptations of the above examples may occur to those skilled in the art. Such modifications and adaptations are in the scope of the disclosure.

What is claimed is:

1. A method of deploying at least one signal cable through a coiled-tubing strand, the method comprising:
installing a front end bullet at a leading end of the signal cable;
installing at least one dissolvable bullet on the signal cable at an intermediate location along the signal cable such that the at least one dissolvable bullet protrudes radially from the signal cable at the intermediate location spaced from the front end bullet;
positioning the leading end of the signal cable into a conduit assembly that extends to a first end of the coiled tubing strand;
injecting a pushing fluid into the conduit assembly to apply a drive force to both the front end bullet and the at least one dissolvable bullet to thereby drive the signal cable into the coiled tubing strand through the conduit assembly; and
injecting a solvent fluid into the conduit assembly to thereby dissolve the at least one dissolvable bullet.

2. The method according to claim 1, further comprising either retrieving the front end bullet from a second end of the coiled tubing strand at a surface location or dissolving the front end bullet within the coiled tubing strand at the surface location.

3. The method according to claim 2, further comprising interrupting injection of the pushing fluid prior to retrieving or dissolving the front end bullet, installing the at least one dissolvable bullet on the signal cable while the injection of the pushing fluid is interrupted, and resuming the injection of the pushing fluid.

4. The method according to claim 3, further comprising creating an opening in the conduit assembly while the injection of the pushing fluid is interrupted, installing the at least one dissolvable bullet through the opening and subsequently closing the opening and resuming the injection of pushing fluid.

5. The method according to claim 4, further comprising inserting the leading end of the signal cable and the front end bullet through an end of the conduit assembly disposed upstream of the opening.

6. The method according to claim 1, wherein installing the at least one dissolvable bullet on the signal cable includes coupling at least two split body portions to one another around the signal cable.

7. The method according to claim 6, wherein injecting the solvent fluid to thereby dissolve the at least one dissolvable bullet includes dissolving a fastener constructed of a dissolvable material to permit the at least two split body portions to separate from one another and separate from the signal cable.

8. The method according to claim 7, further comprising discharging the at least split body portions from the second end of the coiled tubing string.

9. The method according to claim 6, wherein injecting the solvent fluid to thereby dissolve the at least one dissolvable bullet includes dissolving the at least two split body portions with the solvent fluid within the coiled tubing strand.

10. The method according to claim I, wherein injecting the solvent fluid to dissolve the at least one dissolvable bullet includes injecting a hydrochloric acid solution into the conduit assembly.

11. The method according to claim 1, wherein installing the at least one dissolvable bullet on the signal cable includes installing a plurality of dissolvable bullets at predetermined intervals along the signal cable.

12. The method according to claim 11, wherein the predetermined interval is selected based on an inner diameter of the coiled tubing strand.

13. The method according to claim 1, further comprising flowing the pushing fluid through the coiled tubing strand and around the front end bullet within the coiled tubing strand.

14. A system for deploying a signal cable through a coiled-tubing strand, the system comprising:
a front end bullet selectively attachable to a leading end of the signal cable;
at least one dissolvable bullet selectively attachable to an intermediate location of the signal cable spaced from the leading end;
a conduit assembly coupled to a first end of the coiled tubing strand and in fluid communication therewith;
a source of pushing fluid fluidly coupled to the conduit assembly, the pushing fluid selectively releasable into the conduit assembly to apply a drive force to both the front end bullet and the at least one dissolvable bullet to thereby drive the signal cable into the coiled tubing strand through the conduit assembly;
a source of solvent fluid selectively injectable into the conduit assembly to thereby dissolve the at least one dissolvable bullet within the coiled tubing strand; and
an opening defined in the conduit assembly to provide access to an intermediate location of the signal cable when the leading end of the signal cable is disposed within the coiled tubing strand.

15. The system according to claim 14, wherein the at least one dissolvable bullet includes at least two split body portions selectively attachable to one another around the signal cable through the opening in the conduit assembly to thereby couple the at least one dissolvable bullet to the signal cable.

16. The system according to claim 15, wherein the at least one dissolvable bullet includes a fastener constructed of a dissolvable material responsive to exposure to the solvent fluid to dissolve and thereby permit the at least two split body portions to separate from one another and separate from the signal cable.

17. The system according to claim 14, wherein at least a portion of the at least one dissolvable bullet is constructed of polyglycolic acid (PGA).

18. The system according to claim 17, wherein the solvent fluid includes a hydrochloric acid solution.

19. The system according to claim 14, wherein the front end bullet is substantially smaller than an inner diameter of the coiled tubing strand such that the front end bullet maintains a substantially unsealed relation with the coiled tubing strand when disposed therein.

20. The system according to claim 14, wherein the source of solvent fluid has a temperature or salinity that is different than a temperature or salinity of the pushing fluid such that exposure to the pushing fluid does not induce dissolving of the at least one dissolvable bullet.
